(19) United States
(12) Patent Application Publication
(10) Pub. No.: US 2014/0224402 A1
(43) Pub. Date: Aug. 14, 2014

(54) TIRE COMPRISING A LAYER OF CIRCUMFERENTIAL REINFORCING ELEMENTS

(71) Applicants: Gilles Sallaz, Clermont-Ferrand-Cedex 9 (FR); Alain Domingo, Clermont-Ferrand-Cedex 9 (FR); Francois Barbarin, Clermont-Ferrand-Cedex 9 (FR); Aurore Lardjane, Clermont-Ferrand-Cedex 9 (FR); Robert Ciprian Radulescu, Clermont-Ferrand-Cedex 9 (FR)

(72) Inventors: Gilles Sallaz, Clermont-Ferrand-Cedex 9 (FR); Alain Domingo, Clermont-Ferrand-Cedex 9 (FR); Francois Barbarin, Clermont-Ferrand-Cedex 9 (FR); Aurore Lardjane, Clermont-Ferrand-Cedex 9 (FR); Robert Ciprian Radulescu, Clermont-Ferrand-Cedex 9 (FR)

(73) Assignees: MICHELIN RECHERCHE ET TECHNIQUE S.A., Granges-Paccot (CH); COMPAGNIE GENERALE DES ETABLISSEMENTS MICHELIN, Clermont-Ferrand (FR)

(21) Appl. No.: 14/232,401

(22) PCT Filed: Jul. 11, 2012
(86) PCT No.: PCT/EP2012/063577

§ 371 Date: Apr. 23, 2014

(30) Foreign Application Priority Data
Jul. 12, 2011 (FR) 1156358

(51) Int. Cl. B60C 9/18

(52) U.S. Cl. CPC B60C 9/18; B60C 2009/1828
USPC 152/527

(57) ABSTRACT

The invention relates to a tire comprising a crown reinforcement formed of at least two working crown layers of reinforcing elements, and of at least one layer of circumferential reinforcing elements.

According to the invention, the reinforcing elements of the said at least two working crown layers have a diameter less than 1.1 mm and satisfy the following relationships:

(Fr×4 cos² α)/(P×0.75×Ø)<5,

Fr₁/(P₁×sin|α₁|)≧1.2 Fr₂/(P₂×sin|α₂|).

This application is a 371 of PCT/EP2012/063577, filed 11 Jul. 2012, which claims benefit of FR1156358, filed 12 Jul. 2011, the entire contents of each of which is incorporated by reference herein for all purposes.

### BACKGROUND

1. Field

Disclosed herein is a tire with a radial carcass reinforcement and more particularly a tire intended to be fitted to vehicles carrying heavy loads such as, for example, lorries, tractors, trailers or buses.

2. Description of Related Art

In general, in tires of the heavy goods vehicle type, the carcass reinforcement is anchored on each side in the region of the bead and is surmounted radially by a crown reinforcement consisting of at least two superposed layers formed of threads or cords which are parallel within each layer and crossed from one layer to the next, making angles of between 10 and 45° with the circumferential direction. The said working layers, which form the working reinforcement, may even be covered with at least one layer known as a protective layer and formed of reinforcing elements which are advantageously made of metal and extensible, known as elastic elements. It may also comprise a layer of metal cords or threads of low extensibility making with the circumferential direction an angle of between 45° and 90°, this ply, referred to as the triangulation ply, being situated radially between the carcass reinforcement and the first crown ply known as the working crown ply, formed of parallel threads or cords making angles at most equal to 45° in terms of absolute value. The triangulation ply, together with at least the said working ply, forms a triangulated reinforcement which, under the various stresses it encounters, deforms very little, the triangulation ply having the essential role of reacting the transverse compressive forces to which all of the reinforcing elements in the crown region of the tire are subjected.

Cords are said to be inextensible when the said cords exhibit, under a tensile force equal to 10% of the breaking force, a relative elongation of at most 0.2%.

Cords are said to be elastic when the said cords exhibit, under a tensile force equal to the breaking load, a relative elongation of at most 3% with a maximum tangent modulus of less than 150 GPa.

Circumferential reinforcing elements are reinforcing elements which make, with the circumferential direction, angles contained in the range +2.5°, −2.5° about 0°.

The circumferential direction of the tire, or longitudinal direction, is the direction corresponding to the periphery of the tire and defined by the direction in which the tire runs.

The transverse or axial direction of the tire is parallel to the axis of rotation of the tire.

The radial direction is a direction that intersects the axis of rotation of the tire and is perpendicular thereto.

The axis of rotation of the tire is the axis about which it turns during normal use.

A radial or meridian plane is a plane containing the axis of rotation of the tire.

The circumferential median plane or equatorial plane is a plane perpendicular to the axis of rotation of the tire and which divides the tire into two halves.

As far as the metal cords or threads are concerned, the breaking force (maximum load in N), breaking strength (in MPa) and elongation at break (total elongation in %) measurements are taken under tensile load in accordance with standard ISO 6892, 1984.

Certain present-day tires known as “road” tires are intended to run at high average speeds over increasingly long journeys because of the improvements to the road network and the growth of the motorway network throughout the world. All of the conditions in which such a tire has to run undoubtedly allows an increase in the distance that the tire can cover, because tire wear is lower, but this increase in life in terms of distance covered, combined with the fact that such wear conditions are likely, under heavy load, to lead to relatively high crown temperatures dictates the need for an at least proportional increase in the durability of the crown reinforcement of the tires.

This is because there are stresses in the crown reinforcement and more particularly shear stresses between the crown layers which, in the event of too high an increase in the operating temperature at the ends of the axially shortest crown layer, have the effect of causing cracks to appear and spread through the rubber at the said ends. The same problem is encountered in the case of the edges of two layers of reinforcing elements, the said other layer not necessarily having to be radially adjacent to the first.

In order to improve the endurance of the crown reinforcement of the tires, French application FR 2 728 510 proposes positioning, on the one hand between the carcass reinforcement and the carcass reinforcement working ply radially closest to the axis of rotation an axially continuous ply formed of inextensible metal cords that make an angle of at least equal to 60° with the circumferential direction and the axial width of which is at least equal to the axial width of the shortest working crown ply and, on the other hand, between the two working crown plies an additional ply formed of metal elements directed substantially parallel to the circumferential direction.

To complement that, French application WO 99/24269 notably proposes, on each side of the equatorial plane and in the immediate axial continuation of the additional ply of reinforcing elements substantially parallel to the circumferential direction, that the two working crown plies formed of reinforcing elements that are crossed from one ply to the next be coupled over a certain axial distance and then later uncoupled using profiled elements of rubber compound at least over the remainder of the width that the said two working plies have in common

The layer of circumferential reinforcing elements is usually made up of at least one metal cord which is wound into a turn laid at an angle of less than 8° with respect to the circumferential direction. The cords initially manufactured are coated with a rubber compound before being laid. This rubber compound will then penetrate the cord under the effect of the pressure and temperature of the vulcanizing of the tire.

Whatever the envisaged solutions such as those set out hereinabove, the presence of an additional layer of reinforcing elements leads to a greater mass of the tire and to higher tire manufacturing costs.

Document WO 10/069676 proposes a layer of circumferential reinforcing elements which are distributed at a variable spacing. Depending on the spacings chosen, more widely spaced in the central and intermediate parts of the layer of circumferential reinforcing elements, it is possible to create tires that have satisfactory endurance performance. By comparison with a tire comprising a layer of circumferential reinforcing elements distributed at a constant spacing, it is possible to reduce the mass and cost although it is necessary to make up for the absence of reinforcing elements by using masses of polymer.

Other ways of limiting the increase in mass of the tire in the presence of an additional ply of circumferential reinforcing elements may involve either omitting the ply referred to as the triangulation ply by comparison with more usual configurations or lightening the working crown plies, or even a combination of both. The working crown plies may then be lightened for example by increasing the spacing at which the cords are distributed or alternatively by using reinforcing elements of smaller diameter and smaller cross section as described for example in document U.S. Pat. No. 3,240,249. It should be noted that this reduction in diameter and cross section of the reinforcing elements is very often accompanied by an increase in the toughness of the steel which limits or compensates for the penalty in terms of breaking force.

The additional ply of circumferential reinforcing elements, upon prolonged running at high speed, is subjected to a fatigue mechanism which is most keenly felt at the edges of the ply and may lead to cord breakage. Such breakages can be avoided or at the very least limited by tailoring the modulus of such an additional ply to make it possible to limit the maximum tensions borne by the cords. This tailoring of the modulus is obtained for example through the use of cords of an elastic type.

Moreover, when an isolated obstacle of a relatively large size is accidentally driven over, all of the plies are suddenly subjected to extensive deformation which may go so far as to completely break the crown block. This type of damage of an accidental origin is conventionally qualified as “road hazard”.

### SUMMARY

It has been found that the ability of a tire comprising working crown plies that have been lightened, in the presence of an additional ply of circumferential reinforcing elements like those described hereinabove, to withstand road hazards may prove to be very significantly reduced. What happens is that being less highly stressed because of its lower modulus the additional ply of circumferential reinforcing elements makes little contribution towards reacting the additional loads generated by the very extensive deformation. Most of this deformation is then absorbed by the working crown plies which, because they have been lightened, prove to be highly sensitized to the risk of breakage.

It is one object of embodiments of the invention to supply tires for “heavy goods” vehicles in which the compromise between endurance performance, ability to withstand road hazards and mass is optimized by comparison with that of the tires as described hereinabove.

This object is achieved, in accordance with embodiments of the invention, by a tire with a radial carcass reinforcement comprising a crown reinforcement formed of at least two working crown layers of reinforcing elements, crossed from one layer to the other making with the circumferential direction angles of between 10° and 45°, itself capped radially by a tread, the said tread being connected to two beads via two sidewalls, the crown reinforcement comprising at least one layer of circumferential reinforcing elements, the reinforcing elements of the said at least two working crown layers having a diameter less than or equal to 1.1 mm and satisfying the following relationships:

(Fr×4 cos² α)/(P×0.75×Ø)<5,

Fr₁/(P₁×sin|α₁|)≧1.2 Fr₂/(P₂×sin|α₂|)

where Frᵢ is the breaking force of the reinforcing elements of layer i measured on reinforcing elements taken from the tire and expressed in daN,

Fr=(Fr₁+Fr₂)/2 is the mean breaking force of the said at least two layers,

αᵢ is the angle formed between the reinforcing elements of the working crown layer i and the circumferential direction at the equatorial plane,

α=(|α₁|+|α₂|)/2 is the mean angle of the said at least two layers,

Pi is the distribution spacing, at the equatorial plane, of the reinforcing elements of the working crown layer i, expressed in mm,

P=(P₁+P₂)/2 is the mean spacing of the said at least two layers,

Pg is the nominal inflation pressure of the tire, expressed in daN/mm²,

Ø is the internal diameter of the tire measured in the equatorial plane and expressed in mm

For preference, according to embodiments of the invention, the reinforcing elements of the said at least two working crown layers have a diameter d less than or equal to 1 mm.

Within the meaning of the invention, the mean angle a corresponds to the mean of the absolute values of the angles αᵢ formed between the reinforcing elements of the said at least two working crown layers and the circumferential direction in the equatorial plane. The angles αᵢ are measured on an unfitted tire.

Within the meaning of the invention, the spacing in part of the layer of reinforcing elements is the distance between two consecutive reinforcing elements. It is measured between the longitudinal axes of the said reinforcing elements in a direction perpendicular to at least one of the said longitudinal axes. The spacings Pi of the said at least two working crown layers are measured on an unfitted tire.

The internal diameter Ø is measured on a tire that has been fitted and inflated to the nominal inflation pressure Pg.

The diameter d of the reinforcing elements of the said at least two working layers is measured on reinforcing elements taken from the tire and rid beforehand of any external polymer residue.

The results obtained with tires according to embodiment of the invention actually demonstrated that for performance that was at least equivalent in terms of endurance, the tires according to the invention exhibit a lower mass while at the same time having a satisfactory ability to withstand road hazards. What has happened is that the reduction in the diameter of the reinforcing elements in the working layers as compared with that of the said reinforcing elements in the conventional tires leads to an entirely noticeable weight saving. The usual diameter of the said reinforcing elements is usually greater than 1.3 mm. The relationship (Fr×4 cos² α)/(P×0.75 Pg×Ø)<5 for its part expresses a condition whereby the inventors consider to be sufficient the improvement in terms of circumferential rigidity by the working layers notably in the crown of the tire when considering the presence of at least one layer of reinforcing elements which are orientated circumferentially. Whereas the conventional tires are usually formed of two identical working crown plies, which means to say plies made up of the same cords laid at the same spacings, crossed from one layer to the other and possibly different from one another by slightly different angles with respect to the circumferential direction, the relationship Fr₁/(P₁×sin|α₁|)≧1.2 Fr₂/(P₂×sin|α₂|) expresses a differentiation between the two working crown layers aimed at equalizing the contribution made by each of the two working crown layers to the reacting of load under extensive deformation in order to push back the threshold at which the crown unit breaks when a road hazard is encountered.

The inventors have also been able to demonstrate that lightening the crown reinforcement of the tire comes with a reduction of its thickness because of the reduction in the diameter of the reinforcing elements in the working layers. This reduction in the thickness of the working reinforcement is associated with polymer compound thicknesses that are smaller by comparison with those used in conventional tires and thus makes it possible to reduce dissipation of heat when the tires are being driven on. The tires according to the invention thus exhibit lower rolling resistance. Further, the reduction in temperatures and notably the reduction in temperatures at the shoulders of the tire means that the risk of cracks appearing at the ends of the working layers can be reduced and therefore contributes to performance in terms of endurance.

The inventors have also demonstrated that the reduction in circumferential rigidity resulting from the lightening of the working layers makes it possible to reduce the said overall circumferential rigidity of the crown reinforcement of the tire and notably to reduce that at the center of the tire, i.e. around the equatorial plane, and thus makes it possible to improve tire properties in terms of wear. Specifically, the occurrence of wear that is uneven between the center and the edge of the tread that occurs under certain running conditions is reduced by comparison with what is seen on more conventional designs. Reducing the diameters of the reinforcing elements of the said at least two working layers also makes it possible to reduce the sensitivity of the tire to attack of the tread, the crown design according to the invention being more flexible overall than it is on more conventional tires.

According to one preferred embodiment of the invention the reinforcing elements of the said at least two working layers are inextensible reinforcing elements. For preference also, these are metal cords.

According to one advantageous alternative form of the invention, the reinforcing elements of the said at least two working layers are metal cords with saturated layers which, on what is known as the permeability test, return a flow rate less than 5 cm³/min.

Within the meaning of the invention, a saturated layer of a layered cord is a layer made up of threads in which there is not enough space for at least one additional thread to be added to it.

The test referred to as the permeability test is used to determine the longitudinal air-permeability of the tested cords, by measuring the volume of air passing under a constant pressure through a test specimen over a given period of time. The principle of such a test, which is well known to those skilled in the art, is to demonstrate the effectiveness of the treatment given to a cord at rendering the cord impermeable to air; it is described for example in standard ASTM D2692-98.

The test is carried out on cords taken directly, by cutting out, from the vulcanized rubber plies that they reinforced. and which have therefore been penetrated with cured rubber. In the case of wrapped cords, the test is performed after removal of the plied or unplied spun yarn used as wrapping wire.

The test is carried out on a 2 cm length of cord, which is therefore coated with its surrounding rubber composition (or coating rubber) in the cured state, as follows: air is injected into the inlet end of the cord, at a pressure of 1 bar, and the volume of air at the outlet is measured using a flow meter (calibrated for example from 0 to 500 cm³/min). During measurement, the cord test specimen is immobilized in a compressed airtight seal (for example a seal made of dense foam or of rubber) so that only the amount of air passing through the cord from one end to the other along its longitudinal axis is considered in the measurement; the airtightness of the airtight seal itself is verified beforehand using a solid rubber, i.e. one without a cord in, test specimen.

The higher the longitudinal impermeability of the cord, the lower the mean air flow rate measured (averaged over 10 test specimens). As the measurement is made with a precision of ±0.2 cm³/min, measured values of 0.2 cm³/min or below are considered as zero; they correspond to a cord that can be qualified as airtight (completely airtight) along its axis (i.e. in its longitudinal direction).

This permeability test also constitutes a simple means for indirectly measuring the degree of penetration of the cord by a rubber composition. The higher the degree to which the rubber has penetrated the cord, the lower the flow rate measured.

Cords which, on what is referred to as the permeability test, return a flow rate of less than 20 cm³/min, exhibit a degree of penetration higher than 66%.

Cords which, on what is referred to as the permeability test, return a flow rate of less than 2 cm³/min, exhibit a degree of penetration greater than 90%.

The degree of penetration of a cord can also be estimated using the method described hereinafter. In the case of a layered cord, the method involves first of all removing the outer layer on a test specimen of between 2 and 4 cm in length so that the sum of the lengths of rubber compound with respect to the length of the test specimen can then be measured in a longitudinal direction and along a given axis. These measurements of the lengths of rubber compound exclude the unpenetrated spaces along this longitudinal axis. These measurements are repeated on three longitudinal axes distributed over the periphery of the test specimen and repeated on five test specimens of cord.

When the cord comprises several layers, the first, removal, step is repeated on the layer that has newly become the outer layer and the measurements of lengths of rubber compound along longitudinal axes are repeated also.

A mean of all the ratios of lengths of rubber compound to the lengths of test specimen which have been determined in this way is then calculated in order to define the degree of penetration of the cord.

The inventors have been able to demonstrate that a tire produced in this way according to the invention leads to improvements in terms of endurance notably when this tire is subjected to excessive stress.

For preference also according to the invention, the cords of the said at least two working layers return, on what is known as the permeability test, a flow rate of less than 2 cm³/min.

According to one advantageous embodiment of the invention, the said metal reinforcing elements which, on what is referred to as the permeability test, return a flow rate of less than 5 cm³/min in the said at least two working layers are cords having at least two saturated layers, at least one inner layer being sheathed with a layer consisting of a polymer compound such as a crosslinkable or crosslinked rubber compound, preferably based on at least one diene elastomer.

The expression “composition based on at least one diene elastomer” means, in a known way, that the composition contains predominantly (i.e. a percentage by weight in excess of 50%) of diene elastomers.

It will be noted that the sheath according to the invention extends continuously around the layer that it covers (i.e. this sheath is continuous in the “orthoradial” direction of the cord which is perpendicular to its radius), so as to form a continuous sleeve the cross section of which is advantageously practically circular.

It will also be noted that the rubber composition of this sheath is crosslinkable or crosslinked, i.e. that it comprises by definition a crosslinking system designed to allow the composition to become crosslinked when it is cured (i.e. to allow it to harden rather than melt); thus, this rubber composition may be qualified as non-melting, because it cannot be melted by heating, whatever the temperature it is heated to.

A “diene” elastomer or rubber means, in the known way, an elastomer derived at least in part (i.e. homopolymer or copolymer) from diene monomers (monomers bearing two carbon-carbon double bonds, conjugated or unconjugated).

For preference, the rubber sheath crosslinking system is a system referred to as a vulcanizing system, i.e. one based on sulphur (or on a sulphur donor) and a primary vulcanization accelerator. Various known vulcanization activators or secondary accelerators may be added to this basic vulcanization system.

The rubber composition of the sheath according to embodiments of the invention comprises, in addition to the said crosslinking system, all the usual ingredients that can be used in rubber compositions for tires, such as reinforcing fillers based on carbon black and/or on a reinforcing inorganic filler such as silica, anti-ageing elements, for example anti-oxidants, extension oils, plasticizers or processability agents, methylene acceptors and donors, resins, bismaleimides, known adhesion-promoting systems of the “RFS” (resorcinol-formaldehyde-silica) type or metal salts, notable cobalt salts.

For preference, the composition of the rubber sheath has, in the crosslinked state, a secant tensile modulus at 10% elongation (denoted M10), measured in accordance with standard ASTM D 412 of 1998, that is less than 20 MPa and more preferably less than 12 MPa and in particular between 4 and 11 MPa.

By way of preference, the composition of this sheath is chosen to be identical to the composition used for the calendering layer of the working crown layer that the cords according to the invention are intended to reinforce. Thus, there is no problem of potential incompatibility between the respective materials of the sheath and of the rubber matrix.

According to an alternative form of the invention, the reinforcing elements, of the said at least two working layers which, on what is known as the permeability test, return of flow rate of less than 5 cm³/min, are layered metal cords of construction [L+M], comprising a first layer C1 of L threads of diameter d₁ wound together in a helix at a pitch p₁ where L ranges from 1 to 4, surrounded by a layer C2 of M threads of diameter d₂ wound together in a helix at a pitch p₂ with M ranging from 3 to 12, a sheath made of a crosslinkable or crosslinked rubber composition based on at least one diene elastomer covering said first layer C1.

For preference, the diameter of the threads in the first layer of the internal layer C1 is between 0.10 and 0.5 mm and the diameter of the threads of the outer layer C2 is between 0.10 and 0.5 mm.

Preferably also, the helix pitch p₂ at which the said threads of the outer layer C2 are wound is between 8 and 25 mm.

Within the meaning of the invention, the helix pitch represents the length, measured parallel to the axis of the cord, after which a thread of this pitch has made a complete turn around the axis of the cord; thus, if the axis is sectioned by two planes perpendicular to the said axis and separated by a length equal to the helix pitch of a thread of a layer that makes up the cord, the axis of this thread in these two planes occupies the same position on the two circles corresponding to the layer of the thread in question.

Advantageously, the cord has one, and more preferably still, all, of the following features which is satisfied:
The layer C2 is a saturated layer, which means to say that there is not enough space in this layer for at least one (N+1)th thread of diameter d₂ to be added to it, N representing the maximum number of threads that can be wound in a layer around the layer C1;
The rubber sheath also covers the internal layer C1 and/or separates the adjacent threads of the outer layer C2 one from the next;
The rubber sheath covers practically half the radially inner circumference of each thread of the layer C2 such that it separates adjacent threads of this layer C2 one from the next.

For preference, the rubber sheath has a mean thickness ranging from 0.010 mm to 0.040 mm.

In general, the said cords according to embodiments of the invention may be produced with any type of metal wires, notably steel wires, for example wires made of carbon steel and/or wires made of stainless steel. Use is preferably made of a carbon steel but it is of course possible to use other steels or other alloys.

When a carbon steel is used, its carbon content (wt. % of steel) is preferably between 0.1% and 1.2%, more preferably from 0.4% to 1.0%; these contents representing a good compromise between the mechanical properties required for the tire and the processability of the wire. It should be noted that a carbon content of between 0.5% and 0.6% makes such steels ultimately less expensive because they are easier to draw. Another advantageous embodiment of the invention may also, depending on the target applications, consist in using steels with a low carbon content, for example of between 0.2% and 0.5%, notably because of the lower cost and greater ease of drawing.

The said cords according to embodiments of the invention may be obtained using various techniques known to those skilled in the art, for example in two stages, first of all by sheathing the core or layers C1 using an extrusion head, which stage is then followed in a second step by a final operation of cabling or twisting the remaining M wires (layer C2) around the layer C1 thus sheathed. The problem of raw-state tack presented by the sheath of rubber, during any intermediate spooling and unspooling operations there might be can be solved in ways known to those skilled in the art, for example by use of an interleaved plastic film.

Such cords of at least one working crown layer are for example selected from the cords described in patent applications WO 2006/013077 and WO 2009/083212.

According to a preferred alternative form of the invention, the spaces Pᵢ at which the reinforcing elements of the said at least two working layers are distributed satisfy the relationship:

1.6 dᵢ≦Pᵢ≦dᵢ+1.3,

where dᵢ are the diameters of the reinforcing elements of the said at least two working layers, expressed in mm

Such a distribution of the reinforcing elements in the said at least two working layers makes it possible, notably under particularly severe driving conditions with high levels of side slip, to optimize the compromise between making the tire lighter and the performance of the tire in terms of crown reinforcement endurance.

Advantageously also according to embodiments of the invention, the mean angle a formed by the reinforcing elements of the said at least two working layers with the circumferential direction is greater than 20°. Such angle values make it possible to limit the shear stresses within the polymer compounds notably at the ends of the said at least two working layers and therefore to reduce the dissipation of heat when the tires are being driven on. The tires according to the invention thus exhibit lower rolling resistance and a lower shoulder temperature and this contributes to performance in terms of endurance.

According to one advantageous embodiment of the invention the reinforcing elements of the said at least one layer of circumferential reinforcing elements are distributed over the axial width of the said at least one layer at a spacing that is variable, notably in order to contribute to making the tire lighter. Advantageously also, the density of reinforcing elements is lower at the center of the said layer of circumferential reinforcing elements than it is at the edges, so as to promote performance in terms of endurance and wear. Such a layer of circumferential reinforcing elements is, for example, produced in accordance with the description of patent application WO 2010/069676.

Within the meaning of the invention, the spacing in part of the layer of circumferential reinforcing elements is the distance between two consecutive reinforcing elements. It is measured between the longitudinal axes of the said reinforcing elements in a direction perpendicular to at least one of the said longitudinal axes. It is therefore measured in a substantially axial direction.

Advantageously also according to an alternative form of the invention, the axial curvatures of the reinforcing layers of the carcass reinforcement and of the reinforcing layers of the crown reinforcement are almost concentric at all the points on the profile of the wear surface and therefore with that of the tread. According to this alternative form of the invention, it is even possible to make the tire lighter. This is because conventional tires usually have an additional layer of rubber compounds positioned under the tread so that it is centered on the circumferential median plane, the presence of such a layer making it possible to obtain a radius of the axial curvature of the tread that is less than that of the axial curvature of the reinforcing layers of the crown reinforcement. Tires produced according to this alternative form of the invention do not have such a layer and so can be lighter. The absence of such a layer may also contribute to limiting the heating-up of the tire when it is used and therefore contribute to its performance in terms of endurance.

Such an alternative form of the invention can be achieved with reinforcing elements of the said at least one layer of circumferential reinforcing elements which are stranded cords displaying a reduction in the maximum tangent modulus between their initial state and extracted-from-the-tire state that is greater than 15 GPa and preferably greater than 20 GPa.

The moduluses expressed hereinabove are measured on a curve of tensile stress as a function of strain, the tensile stress corresponding to the measured tension, with a preload of 5N, with respect to the cross section of metal of the reinforcing element. These measures are taken under tension in accordance with ISO 6892, 1984.

The cords taken from tires on which the measurements are made are taken from tires of which the constituent parts, other than the cords in question, and notably the compounds likely to penetrate the said cords are constituent parts that are commonplace for applications of the heavy goods vehicle tire type.

Such reinforcing elements, of the said at least one layer of circumferential reinforcing elements are, for example, described in patent applications WO 2010/115891 and WO 2010/115892.

According to one preferred embodiment of the invention, at least two working crown layers have different axial width, the difference between the axial width of the axially widest working crown layer and the axial width of the axially narrowest working crown layer being between 10 and 30 mm.

For preference also, the axially widest working crown layer is radially on the inside of the other working crown layers.

According to a preferred embodiment of the invention, at least one layer of circumferential reinforcing elements is arranged radially between two working crown layers.

A first alternative form of the invention then makes provision, with the axial widths of the working crown layers radially adjacent to the layer of circumferential reinforcing elements being greater than the axial width of the said layer of circumferential reinforcing elements, for the two working crown layers not to be coupled.

According to another alternative form of the invention, the axial widths of the working crown layers radially adjacent to the layer of circumferential reinforcing elements are greater than the axial width of the said layer of circumferential reinforcing elements.

According to this alternative form of the invention, the said working crown layers adjacent to the layer of circumferential reinforcing elements are, on each side of the equatorial plane and in the immediate axial continuation of the layer of circumferential reinforcing elements, coupled over an axial width and then uncoupled by profiled elements of rubber compound at least over the remainder of the width that the said two working layers have in common

Within the meaning of the invention, coupled layers are layers in which the respective reinforcing elements are radially separated by at most 1.5 mm, the said thickness of rubber being measured radially between the respectively upper and lower generatrices of the said reinforcing elements.

The presence of such couplings between the working crown layers adjacent to the layer of circumferential reinforcing elements allows a reduction in the tensile stress acting on the axially outermost circumferential elements situated closest to the coupling.

The thickness of the decoupling profiled elements between working plies, measured in line with the ends of the narrowest working ply will be at least equal to two millimeters and preferably greater than 2.5 mm.

According to one advantageous embodiment of the invention, the reinforcing elements of at least one layer of circumferential reinforcing elements are metal reinforcing elements having a secant modulus at 0.7% elongation of between 10 and 120 GPa and a maximum tangent modulus of less than 150 GPa.

According to a preferred embodiment, the secant modulus of the reinforcing elements at 0.7% elongation is less than 100 GPa and greater than 20 GPa, preferably between 30 and 90 GPa and more preferably still, less than 80 GPa.

For preference also, the maximum tangent modulus of the reinforcing elements is less than 130 GPa and more preferably still, less than 120 GPa.

The moduluses expressed hereinabove are measured on a curve of tensile stress as a function of strain, the tensile stress corresponding to the measured tension, with a preload of 5N, with respect to the cross section of metal of the reinforcing element.

According to one preferred embodiment, the reinforcing elements of at least one layer of circumferential reinforcing elements are metal reinforcing elements having a curve of tensile stress as a function of relative elongation, or strain, that exhibits shallow gradients for small elongations and a gradient that is steep and substantially constant for higher elongations. Such reinforcing elements of the additional ply are customarily referred to as “bi-modulus” elements.

According to a preferred embodiment of the invention, the substantially constant and deep gradient appears upwards of a relative elongation of between 0.4% and 0.7%.

The various characteristics of the reinforcing elements which have been listed hereinabove are measured on reinforcing elements that have been taken from tires.

Reinforcing elements more particularly suited to creating at least one layer of circumferential reinforcing elements according to the invention are, for example, assemblies of construction 3×(0.26+6×0.23) 5.0/7.5 SS. Such a cord has a secant modulus 0.7% equal to 45 GPa and a maximum module tangent modulus equal to 100 GPa, these being measured on a curve of tensile stress as a function of strain, the tensile stress corresponding to the tension measured, with a preload of 5N, with respect to the cross section of metal of the reinforcing element, of 0.98 mm² in the case of the example being considered.

According to a second embodiment of the invention, the circumferential reinforcing elements may be formed of metal elements and cut to form portions of a length very much shorter than the circumference of the shortest layer, but preferably greater than 0.1 times the said circumference, the cuts between portions being axially offset from one another. For preference also, the modulus of elasticity in tension per unit width of the additional layer is lower than the modulus of elasticity in tension, measured under the same conditions, of the most extensible working crown layer. Such an embodiment makes it possible in a simple way to give the layer of circumferential reinforcing elements a modulus that can easily be adjusted to suit (by choosing the spacing between portions of the same row) but which is in all cases lower than the modulus of the layer made up of the same metal elements but in which these elements are continuous, the modulus of the additional layer being measured on a vulcanized layer of cut elements, taken from the tire.

According to a third embodiment of the invention, the circumferential reinforcing elements are wavy metal elements, the ratio a/λ of the wave amplitude to the wavelength being at most equal to 0.09. For preference, the modulus of elasticity in tension per unit width of the additional layer is less than the modulus of elasticity in tension, measured under the same conditions, of the most extensible working crown layer.

One preferred embodiment of the invention further provides for the crown reinforcement to be supplemented radially on the outside by at least one additional layer, referred to as a protective layer, of reinforcing elements referred to as elastic reinforcing elements, oriented with respect to the circumferential direction at an angle of between 10° and 45° and in the same direction as the angle formed by the elements of the working layer radially adjacent to it.

The protective layer may have an axial width less than the axial width of the narrowest working layer. The said protective layer may thus have an axial width greater than the axial width of the narrowest working layer, such that it overlaps the edges of the narrowest working layer and, in the case of the radially upper layer being the narrowest, such that it is coupled, in the axial continuation of the additional reinforcement, to the widest working crown layer over an axial width in order then to be uncoupled, axially on the outside, from the said widest working layer by profiled elements of thicknesses of at least 2 mm. The protective layer formed of elastic reinforcing elements may, in the case mentioned hereinabove, be on the one hand potentially uncoupled from the edges of the said narrowest working layer by profiled elements of a thickness substantially smaller than the thickness of the profiled elements that separate the edges of the two working layers and have, on the other hand, an axial width that is less than or greater than the axial width of the widest crown layer.

According to either one of the embodiments of the invention mentioned hereinabove, the crown reinforcement may be further supplemented, radially on the inside, between the carcass reinforcement and the radially inner working layer closest to the said carcass reinforcement, by a triangulation layer of metal reinforcing elements made of steel making, with the circumferential direction, an angle greater than 60° and in the same direction as the angle formed by the reinforcing elements of the radially closest layer of the carcass reinforcement.

### BRIEF DESCRIPTION OF DRAWINGS

Other details and advantageous features of the invention will become apparent hereinafter from the description of exemplary embodiments of the invention made with reference to FIGS. 1 and 2 which depict:

FIG. 1: a schematic meridian view of a tire according to one embodiment of the invention;

FIG. 2: a schematic meridian view of a tire according to a second embodiment of the invention.

### DETAILED DESCRIPTION OF SPECIFIC EMBODIMENTS

For ease of understanding, the figures have not been drawn to scale. The figures depict only half a view of a tire which continues symmetrically about the axis XX′ which represents the circumferential median plane or equatorial plane of a tire.

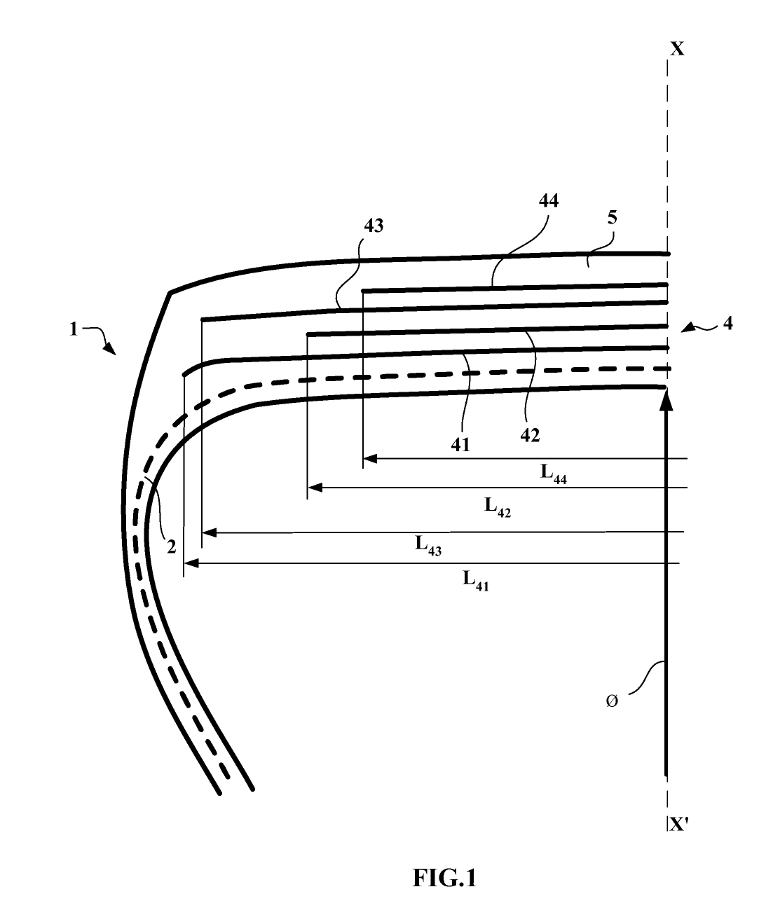

In FIG. 1, the tire 1, of size 315/70 R 22.5 has an aspect ratio H/S equal to 0.70, H being the height of the tire 1 on its mounting rim and S its maximum axial width. The said tire 1 comprises a radial carcass reinforcement 2 anchored in two beads, not depicted in the figure. The carcass reinforcement is formed of a single layer of metal cords. This carcass reinforcement 2 is hooped by a crown reinforcement 4, formed radially from the inside to the outside:
of a first working layer 41 formed of metal cords of construction 0.30 sheathed+6×0.30 15 S, returning, on the permeability test, a zero flow rate, which are continuous across the entire width of the ply and make an angle of 18° with the circumferential direction at the equatorial plane,
of a layer of circumferential reinforcing elements 42 formed of bi-modulus metal cords of construction 3×(0.26+6×0.23)5/7.5 SS,
of a second working layer 43 formed of metal cords of construction 0.30 sheathed+6×0.30 15 S, returning, on the permeability test, a zero flow rate, these being continuous across the entire width of the ply, making an angle of 22° with the circumferential direction at the equatorial plane and crossed with the metal cords of the layer 41,
of a protective layer 44 formed of elastic metal cords of construction 3×2×0.35 4/6 SS.

The crown reinforcement is itself capped by a tread 5.

The maximum axial width S of the tire is equal to 318 mm.

The axial width L₄₁ of the first working layer 41 is equal to 252 mm.

The axial width L₄₃ of the second working layer 43 is equal to 232 mm.

The axial width L₄₂ of the layer of circumferential reinforcing elements 42 is itself equal to 194 mm.

The last crown ply 44, referred to as protective ply, has a width L₄₄ equal to 188 mm.

According to the invention, the cords in the working layers 41 and 43 are two-layer assemblies made up of wires of 0.30 mm. The cords thus formed have a diameter d of 0.95 mm.

The breaking force Fr₁ and Fr₂ of the cords of the working layers 41 and 43 is equal to 155 daN.

The spacing P₁ at which the cords of the working layer 41 are distributed is equal to 1.9 mm. It satisfies the relationship 1.6 d≦P₁≦d+1.3, d being equal to 0.95.

The spacing at P₂ at which the cords of the working layer 43 are distributed is equal to 2.1 mm. It satisfies the relationship 1.6 d≦P₂≦d+1.3, d being equal to 0.95.

The average spacing P is equal to (1.9+2.1)/2, i.e. to 2 mm.

The mean angle a formed between the reinforcing elements of the layers 41 and 43 and the circumferential direction is equal to (18°+22°)/2, i.e. to 20°.

The tire inflation pressure Pg is equal to 0.090 daN/mm².

The internal diameter Ø of the tire measured in the equatorial plane is equal to 954 mm.

The tire according to the invention to which the relationship (Fr×4 cos² α)/P×0.75 Pg×Ø) is applied leads to a value of 4.25 which is therefore lower than 5.

The relationship Fr₁/(P₁×sin|α₁|)≧1.2 Fr₂/(P₂×sin|α₂|) is expressed as 264≧1.2*197=236. The relationship is therefore satisfied.

The combined mass of the working layers 41 and 43 and of the layer of circumferential reinforcing elements 42, including the mass of the metal cords and of the calendering compounds, thus amount to 8.1 kg.

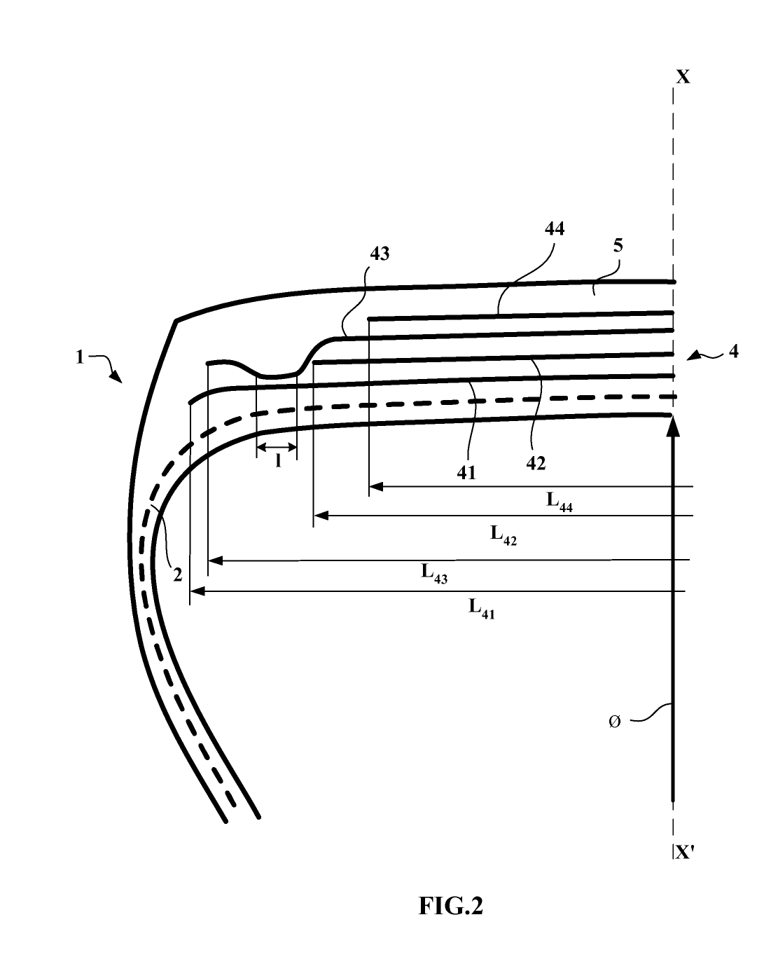

In FIG. 2, the tire 1 differs from the one depicted in FIG. 1 in that the two working layers 41 and 43 are, on each side of the equatorial plane and axially in the continuation of the layer of circumferential reinforcing elements 42, coupled over an axial width 1. Over the remaining width that the two working layers have in common, the two working layers 41, 43 are separated by a profiled element made of rubber, not depicted in the figure, the thickness of the said profiled element increasing from the axial end of the coupling zone towards the end of the narrowest working layer. The said profiled element is advantageously wide enough that it radially overlaps the end of the widest working layer 41 which, in this instance, is the working layer radially closest to the carcass reinforcement.

Tests were carried out using the tire produced according to the invention according to the depiction of FIG. 1 and compared against a reference tire that was identical but produced according to a standard configuration, the cords of the working layers being of formula 9.35.

The reference tire has a design similar to that of the invention in which the reinforcing elements of the working layers are cords of construction 2+7×0.35 7.5/15 SS.

The cords in the working layers of the reference tire have a diameter d of 1.35 mm which is therefore higher than 1.1 mm.

The breaking force Fr of the cords of the working layers of the reference tire is equal to 246 daN.

The space P at which the cords of the working layers of the reference tire are distributed is equal to 2.50 mm.

The angle αᵢ formed between the reinforcing elements of the layers of the reference tire and the circumferential direction is equal to 16.0°.

The tire inflation pressure Pg is 0.090 daN/mm².

The internal diameter Ø of the tire measured in the equatorial plane is equal to 950 mm.

The reference tire to which the relationship (Fr×4 cos² α)/(P×0.75 Pg×Ø) is applied leads to a value of 5.7 which is therefore higher than 5.

The relationship Fr₁/(P₁×sin|α₁|)≧1.2 Fr₂/(P₂×sin|α₂|) is also not satisfied because the two working layers have properties which are similar although the angles are opposite.

For the reference tire, the combined mass of the working layers 41 and 43 and of the layer of circumferential reinforcing elements 42, including the mass of the metal cords and of the calendering compounds, thus amount to 10.1 kg.

The manufacture of the tire produced according to the invention as compared with that of the reference tire therefore, across all the working layers 41 and 43 and the layer of circumferential reinforcing elements 42, demonstrates a weight saving of 2 kg.

First endurance tests were carried out on a test machine that made each of the tires drive in a straight line at a speed equal to the maximum speed index prescribed for the said tire under an initial load of de 4000 kg which was increased gradually over the course of the running.

Other endurance tests were carried out on a test machine that applied a transverse load and a dynamic overload cyclically to the tires. The tests were carried out on tires according to the invention under conditions identical to those applied to the reference tires.

The tests thus carried out showed that the distances covered during each of these tests were practically the same for the tires according to the invention and for the reference tires. It would therefore seem that the tires according to the invention display performance that is substantially equivalent in terms of endurance to that of the reference tires.

Other running tests were carried out on grounds comprising obstacles that were particularly aggressive in terms of road hazard to the treads of the tires.

These last tests showed that, having suffered the same attacks in terms of road hazard, the tires according to the invention shows fewer signs of damage and less extensive damage than the reference tires.

Rolling resistance measurements also showed that the tire according to the invention led to savings of the order of 0.2 kg/T.

Other tires according to the invention which perform just as well in terms of endurance were produced using working layer cords of construction 0.26 sheathed+6×0.26 15 S which on the permeability test returned a zero flow rate. These then were two-layered cords made up of wires of 0.26 mm. The cords thus formed have a diameter d of 0.83 mm.

The breaking force Fri of the cords of the working layers is equal to 131 daN.

The spacing P₁ at which the cords of the working layer 41 are distributed is equal to 1.4 mm. It satisfies the relationship 1.6 d≦P₁≦d+1.3, d being equal to 0.83.

The spacing P₂ at which the cords of the working layer 43 are distributed is equal to 1.9 mm. It satisfies the relationship 1.6 d≦P₂≦d+1.3, d being equal to 0.83.

The mean spacing P is equal to (1.4+1.9)/2, i.e. to 1.65 mm.

The angle α₁ formed between the reinforcing elements of the layer 41 and the circumferential direction is equal to 16°.

The angle α₂ formed between the reinforcing elements of the layer 43 and the circumferential direction is equal to 25°.

The mean angle α formed between the reinforcing elements of the layers 41 and 43 and the circumferential direction is therefore equal to (16+25)/2, i.e. to 20.5°.

The tire inflation pressure Pg is equal to 0.090 daN/mm².

The internal diameter Ø of the tire measured in the equatorial plane is equal to 956 mm.

This second tire thus produced according to the invention and to which the relationship (Fr×4 cos² α)/(P×0.75 Pg×Ø) is applied leads to a value of 4.32 which is therefore below 5.

The relationship Fr₁/ (P₁×sin|α₁|)≧1.2 Fr₂/(P₂×sin|α₂|) can be expressed as 339>1.2*163=196. Therefore the relationship is satisfied.

1- Tire with a radial carcass reinforcement comprising a crown reinforcement formed of at least two working crown layers of reinforcing elements, crossed from one layer to the other making with the circumferential direction angles of between 10° and 45°, itself capped radially by a tread, the said tread being connected to two beads via two sidewalls, the crown reinforcement comprising at least one layer of circumferential reinforcing elements, characterized in that the reinforcing elements of the said at least two working crown layers have a diameter less than 1.1 mm and in that they satisfy the following relationships:
(Fr×4 cos² α)/(P×0.75 Pg×Ø)<5,
Fr₁/(P₁×sin|α₁|)≧1.2 Fr₂/(P₂×|α₂|)
where Frᵢ is the breaking force of the reinforcing elements of layer i measured on reinforcing elements taken from the tire and expressed in daN,
Fr=(Fr₁+Fr₂)/2 is the mean breaking force of the said at least two layers,
αᵢ is the angle formed between the reinforcing elements of the working crown layer i and the circumferential direction at the equatorial plane,
α=(|α₁|+|α₂|)/2 is the mean angle of the said at least two layers,
Pi is the distribution spacing, at the equatorial plane, of the reinforcing elements of the working crown layer i, expressed in mm,
P=(P₁+P₂)/2 is the mean spacing of the said at least two layers,
Pg is the nominal inflation pressure of the tire, expressed in daN/mm²,
Ø is the internal diameter of the tire measured in the equatorial plane and expressed in mm.

2- Tire according to claim 1, characterized in that the spaces Pᵢ at which the reinforcing elements of the said at least two working layers are distributed satisfy the relationship:
1.6 dᵢ≦Pᵢ<dᵢ+1.3,
where dᵢ are the diameters of the reinforcing elements of the said at least two working layers, expressed in mm.

3- Tire according to claim 1 or 2, characterized in that the mean angle formed by the reinforcing elements of the said at least two working layers with the circumferential direction is greater than 20°.

4- Tire according to one of claims 1 to 3, characterized in that the reinforcing elements of the said at least two working layers are inextensible reinforcing elements.

5- Tire according to one of claims 1 to 4, characterized in that the reinforcing elements of the said at least two working layers are metal cords with saturated layers which, on what is known as the permeability test, return a flow rate less than 5 cm³/min.

6- Tire according to one of the preceding claims, characterized in that the reinforcing elements of the said at least one layer of circumferential reinforcing elements are distributed over the axial width of the said at least one layer at a spacing that is variable.

7- Tire according to one of the preceding claims, characterized in that the layer of circumferential reinforcing elements is arranged radially between two working crown layers.

8- Tire according to one of the preceding claims, at least two working crown layers having different axial width, characterized in that the difference between the axial width of the axially widest working crown layer and the axial width of the axially narrowest working crown layer is between 10 and 30 mm.

9- Tire according to claim 8, characterized in that the axially widest working crown layer is radially on the inside of the other working crown layers.

10- Tire according to one of the preceding claims, characterized in that the axial widths of the working crown layers radially adjacent to the layer of circumferential reinforcing elements are greater than the axial width of the said layer of circumferential reinforcing elements.

11- Tire according to claim 10, characterized in that the working crown layers adjacent to the layer of circumferential reinforcing elements are, on each side of the equatorial plane and in the immediate axial continuation of the layer of circumferential reinforcing elements, coupled over an axial width and then uncoupled by profiled elements of rubber compound at least over the remainder of the width that the said two working layers have in common.

12- Tire according to one of the preceding claims, characterized in that the reinforcing elements of at least one layer of circumferential reinforcing elements are metal reinforcing elements having a secant modulus at 0.7% elongation of between 10 and 120 GPa and a maximum tangent modulus of less than 150 GPa.

13- Tire according to one of the preceding claims, characterized in that the reinforcing elements of at least one layer of circumferential reinforcing elements are metal reinforcing elements having a curve of tensile stress as a function of relative elongation that exhibits shallow gradients for small elongations and a gradient that is steep and substantially constant for higher elongations.

14- Tire according to one of claims 1 to 11, characterized in that the reinforcing elements of at least one layer of circumferential reinforcing elements are metal reinforcing elements cut to form portions of a length less than the circumference of the shortest ply, but greater than 0.1 times the said circumference, the cuts between portions being axially offset from one another, the elastic modulus in tension per unit width of the layer of circumferential reinforcing elements preferably being lower than the elastic modulus in tension, measured under the same conditions, of the most extensible working crown layer.

15- Tire according to one of claims 1 to 11, characterized in that the reinforcing elements of at least one layer of circumferential reinforcing elements are wavy metal reinforcing elements, the ratio a/λ of the wave amplitude a to the wavelength λ being at most equal to 0.09, the elastic modulus in tension per unit width of the layer of circumferential reinforcing elements preferably being less than the elastic modulus in tension, measured under the same conditions, of the most extensible working crown layer.
